(19) United States
(12) Patent Application Publication
(10) Pub. No.: US 2012/0235860 A1
(43) Pub. Date: Sep. 20, 2012

(54) Automatic GPS tracking system with passive or active battery circuitry

(76) Inventor: Ohanes D. Ghazarian, Henderson, NV (US)

(21) Appl. No.: 13/374,548

(22) Filed: Nov. 21, 2011

Related U.S. Application Data
(63) Continuation-in-part of application No. 12/001,937, filed on Dec. 12, 2007, now abandoned.
Application No. 12/001,937 is a continuation-in-part of application No. 11/411,164, filed on Apr. 25, 2006, now abandoned.

(51) Int. Cl. G01S 19/12; G01S 19/34; G08B 21/22; G01S 19/16

(52) U.S. Cl. 342/357.4; 342/357.54; 342/357.74

(57) ABSTRACT

An automatic GPS tracking system consists of a GPS tracking unit secured to a person or an asset that includes a GPS receiver and a first battery powering a processor and first RF transceiver. A home base station receives the RF signal within a pre-selected proximity. A monitoring station which is in communication with the GPS tracking unit such that, if a person or asset having the tracking system secured thereon moves beyond the pre-selected proximity from a home base unit, the first transceiver RF communication signals is lost, and the processor activates an alerting device to indicate the GPS tracking unit is beyond the limited range of the home base station unit. When a second confirmation signal is not received from the home base station unit, a second battery is activated to power GPS receiver and the cellular modem to track the person or asset.

### CROSS REFERENCE TO RELATED APPLICATION

This application is a continuation in part of U.S. patent application Ser. No. 12/001,937, filed Dec. 12, 2007, which is a continuation in part of U.S. patent application Ser. No. 11/411,164 filed Apr. 25, 2006.

### TECHNICAL FIELD

The present invention relates to tracking of objects to provide location information. More specifically, the present invention relates to a GPS tracking device worn or securely attached on a person's limb or an asset. The GPS tracking device may utilize an RF transceiver designed to establish communication with a home base unit when the tracking system is located within proximity of a home base unit. The tracking unit may be designed to generate warning signals when the person attached with a tracking devise wanders behind the RF communication proximity range of the home base unit to warn the user is moving away from the home base unit RF communication proximity range, and to avoid the tracking system automatically false reporting that the user left the proximity of a home base unit, and to allow the user to avoid the tracking device making unnecessary reporting to monitoring station personnel to save the tracking device cellular or satellite module from consuming battery. One or preferably two separate batteries may be used as a power supply, which represents definite improvement to the art.

### BACKGROUND OF THE INVENTION

The invention is for tracking of individuals or assets to provide knowledge of their location with tracking GPS tags. When the subject or asset to be monitored moves away from a dedicated area, the invention provides automatic GPS monitored using a GPS unit that does not require frequent battery charging or replacement.

When the subject or asset to be monitored leaves a home base unit dedicated area, the GPS unit RF transceiver circuitry, within a predetermined time, detects RF communication signal loss with a home base unit located within the dedicated area, and switches ON the GPS/Cellular battery power and cold starts the GPS/cellular tracking circuitry. In a preferred embodiment of the invention the RF transceiver automatically switches a secondary battery power on, to cold start (power up) the GPS tracking circuitry to provide its location information. This switching may occur regardless of the power level of a primary battery. The designated area includes but is not limited to; a house, a school, a prison, camp, a vehicle, a warehouse, or an aircraft etc.

In the past many different methods have been used for electronic monitoring of individuals, such as offenders, personnel, assets etc. The most common monitoring is primarily accomplished by use of a worn or attached GPS receiver, having a processor, a global positioning satellite receiver and a wireless modem for two way communication with a monitoring station, all powered by a battery. Prior art has been used for tracking offenders, or an asset based on restraint or allow-ability to enter or exit a dedicated area. This type of system includes a GPS receiver/transmitter for receiving GPS timing signals and a processor utilizing a comparator for calculating and storing a waypoint. An algorithm created by the processor calculates a mapped programmed confinement area starting from a given waypoint, and a perimeter of the physical confinement area. The comparator provides an output comparing the present position of the GPS receiver/transmitter with the programmed confinement area. The comparator output is transmitted by the receiver/transmitter to a monitoring station PC.

Such prior art teachings are found in U.S. Pat. No. 6,232,916 of Grillo et al. and U.S. Pat. No. 6,774,797 of Freathy et al. illustrating useful methods for tracking personnel or assets, in designated areas where a person, or asset, to be monitored is restrained from entering or exiting the defined zone. In order to obtain such functionality, the GPS unit used in the prior art must produce electrical power all of the time while in use. This prior art necessitates constant battery consumption, requiring frequent battery charging or replacement, in order for the GPS receiver to receive satellite signals, the comparator to function and the wireless modem to receive and transmit a signal.

Further, a more useful method found in prior art is illustrated in U.S. Pat. No. 6,104,979 of Harrison, in which he teaches a communication method for both the asset requirement and communication channel occupancy in a reduced order. The asset is provided with an indication of its position so as to allow detection of movement of the asset. Reduced order of the data at the asset, is used for shorter data transmission times. This capability can be used to save energy, for example, reporting to the central station less frequently when the asset position is unchanged. Harrison teaches centralize tracking with reduced energy consumption, however if such teaching were to be implemented in applications where an asset or person to be monitored was in an unchanged position, within a dedicated area, the invention still requires constant battery energy in order to operate GPS tracking device circuitry, even with reporting to central station less frequently.

The following U.S. patents and patent application Publications are considered related:

U.S. Patent Application Publication 2006/0202818 of Greenberg teaches a tracking system, using a battery as power source having multi-power mode. A first mode is a low power mode, when the receiver on the trackee remains within the range of a base station. A second mode, is a standby mode and a third mode is a lost trackee mode that is activated upon user authentication.

U.S. Pat. No. 7,061,385 of Fong, et al. teaches a wireless tether apparatus such that when separated from a base station unit, greater than a predetermined distance, dynamic switching communication channels send information in the form of alarm sounds, displays, vibration sequences or combinations thereof.

U.S. Pat. No. 6,889,135 of Curatolo, et al. illustrate a method wherein if two signaling units are separated more than a pre-selected distance, signaling units are activated transmitting the location of the signaling units.

U.S. Patent Application Publication 2005/0017900 of Grimm teaches a method wherein a reed switch responsive to the magnetic field of a keeper plate, within a bank teller's drawer activates a GPS/cellular modem selectively controlling a cellular or RF transmitter to help recover stolen goods.

U.S. Patent Application Publication 2004/0012518 of Mohan illustrates a method wherein a module, in form of a bracelet, is adapted with a global position satellite receiver, a communications transmitter and a controller, operative to receive a request from a remote location causing the global positioning satellite receiver to receive and decode signals from global positioning satellites containing information relating to the geographic position of the module.

U.S. Patent Application Publication 2002/0018014 of Allen teaches a trigger-able remote controller having a trigger signal including a command; a GPS processor coupled to trigger signal, and a position signal carrying position information generated by the GPS processor in response to trigger signal. The trigger signal source comprises a page receiver with the trigger signal activating when the page receiver receives a page.

U.S. Pat. No. 6,236,358 of Durst, et al. teach an object locator, such as an animal, carrying a mobile communication unit that includes a GPS receiver coupled with a pager transceiver. The GPS receiver may be selectively activated to conserve power by responding only when the GPS receiver is beyond or within a predetermined boundary.

U.S. Pat. No. 6,014,080 of Layson Jr. illustrates a body worn tracking device for use in a wireless communication system receiving signals from a global positioning system. The tracking device directly communicates selected coordinates within remote sites. The device case contains a battery, a signaling device, and a field programmable gate array for power saving.

U.S. Pat. No. 6,075,443 of Schepps et al. teach a method using a wireless tether worn on a article, transmitting a periodic identification signal. A receiving module located at a tether location receives identification signals if the tethered article moves away from the tether location at which time an alarm is raised.

U.S. Pat. No. 6,067,018 of Skelton et al. teaches a pet notification system having a pet collar that automatically activates an alarm when the pet becomes lost. A portable hand held unit continuously monitors the location of the pet. A base station automatically transmits a signal to the owner once portable unit determines that the pet is lost.

U.S. Pat. No. 5,870,029 of Otto et al. illustrate a system for monitoring the location or presence of an object/person within a selected area. The system includes a mobile base station, a control center, a mobile signaling device carried by the monitored object/person and geolocating means for retaining the monitored object/person within a desired area. An alarm condition is raised, when the monitoring object/person is not within this desired area.

U.S. Pat. No. 5,491,486 of Welles, II et al. illustrate a method where a mobile tracking unit is capable of operating in a power starved environment on a vehicle generating data corresponding to vehicle position. A navigation device is periodically energized, at selective activation rate, while vehicle is moving generating a vehicle position. A motion sensor is also employed for generating data indicative of vehicle motion, and.

U.S. Pat. No. 5,515,419 of Sheffer teaches a tracking system for tracking a portable phone, utilizing an array of fixed wireless signal transceivers forming part of a wireless telephone system. The phone unit generates an emergency signal on detection of an emergency condition, and transmits the emergency signal to a monitoring station via the wireless telephone network. The emergency signal includes information for identifying the phone.

U.S. Pat. No. 7,209,771 to Twitchell teaches make use of separate batteries in a portable asset tracking devices, includes a low power RF communication device capable of being powered down to conserve energy and capable of being power up in response to a signal from a second receiver which detects a broadcast signal. Each one of low power communication device and the broadcast receiver may be powered by separate batteries.

U.S. Pat. No. 5,497,149 to Fast teaches conventionality of two battery source.

Prior art teachings found in U.S. Pat. No. 6,075,443 to Schepps et al, U.S. Pat. No. 6,067,018 to Skelton et al, U.S. Pat. No. 5,870,029 to Otto et al. U.S. Pat. No. 5,491,486 to Welles, II et al. U.S. Pat. No. 5,515,419 to Sheffer, U.S. Pat. No. 7,209,771 to Twitchell, and U.S. Pat. No. 5,497,149 to Fast as well as the other prior art GPS tracking systems found are important and useful background to the present invention, but none of prior art teachings address the shortcomings addressed by the GPS tracking system/unit herein as will be described further below.

### SUMMARY OF THE INVENTION

The primary object of the present invention is to provide a GPS tracking system worn or installed on persons for tracking or assets with a global positioning receiver utilizing an RF transceiver to establish communication with a home base unit when the tracking system is located within proximity of a home base unit, the tracking unit is designed to generate warning signals when the person attached with a tracking unit wonders away from the proximity of RF communication range from the home base unit, to warn the user leave the RF communication proximity range of the home base unit, to avoid the tracking device from reporting, and alert the user to avoid the tracking device making unnecessary reports, save network call charges and save tracking device cellular or satellite module consuming battery, the unit utilizing two separate batteries for the power supply. The invention consists of a GPS tracking unit, having a processor, a GPS receiver and a satellite or cellular modem and a low power consumption RF transceiver, and a user warning alarm signaling circuitry. The GPS tracking unit utilizes a first battery for its power supply, communicating with an RF signal at time intervals with a home base station RF transceiver unit, located in a pre-selected area within the communication range of the GPS tracking unit.

The GPS tracking unit has a dedicated second rechargeable battery providing power to the GPS receiver and wireless modem circuitry. When the GPS unit is present within communication range of home base unit, the GPS unit's receiver, satellite or cellular modem battery power circuitry is in “Off” position.

If and when the asset carrying the GPS tracking unit moves out of communication range from the home base unit, the GPS tracking unit's RF transceiver circuitry, at predetermined time, detects RF communication signal loss, and generate warning signals to warn the is away from RF communication proximity range of the home base unit, if user choose to move away, the tracking device processor switching circuitry “Powers On” the second battery to operate the GPS tracking unit receiver and satellite or cellular modem circuitry. The invention provides automatic tracking when a person or asset moves away from a pre-selected area, and conserves GPS tracking unit batteries, as only the second battery is supplying power when the GPS receiver is in use, thus providing longer period of portable GPS tracking unit operation than other prior art systems using a single battery for all functions.

The GPS/cellular circuitry may have no battery power consumption at all when the GPS tracking unit is located within proximity of a home base unit. The present art thus provides longer battery life for GPS tracking.

The GPS tracking system of the present invention may utilize two batteries: a rechargeable battery to provide power to the RF transceiver, to the processor and to GPS/cellular or satellite module, and a rechargeable back up battery is used as a back up to supply power when the rechargeable battery is removed from the tracking device for charging, the rechargeable battery after being charged is inserted in the tracking devise and used for operating the tracking device and for charging the rechargeable back up battery. and a power switching circuitry configured at a predetermined time to transfer power from the rechargeable battery or rechargeable back up battery to the GPS receiver and cellular or satellite transceiver if the confirmation signal is not received after the alerting device is activated at least the first time;

The GPS tracking system of the present invention being securely attached to the user limp may contain a two way voice cellular or satellite module having a blue tooth RF transceiver circuitry which is designed to ascertain user to receive incoming phone calls from a monitoring station and accordingly signal the user with audio/visual or vibrating signals to activate the user headset to establish two way voice communication with the monitoring station.

The GPS tracking unit may be configured such that when it is located within a predefined proximity of a home base unit (communicating with a low power RF signal with a home base unit), the tracking device GPS/Cellular electronic circuitry power consumption is completely off consuming no power from the battery. It is not on stand by mode draining small amount of current as found in prior art teaching, and the tracking device is configured to activate a signaling device when the GPS tracking unit is outside the proximity communication distance. A vibrator or beeper may be used as a signaling device to notify the person wearing the GPS tracking unit that he or she has gone too far from the home base unit. The person may then return to a location within the proximity communication distance to avoid the tracking unit from reporting. For instance, if the person returns to a location within the proximity communication distance within a predefined time, GPS tracking and notification to a monitoring station (that the person is outside the proximity communication distance) may not be activated. This reduces the number of false alarm reporting and allows the person to move more freely without being preoccupied of whether or no he or she is outside the proximity communication distance.

In addition, battery life is preserved since GPS tracking and notification may remain deactivated from false alarm reporting. To illustrate, the battery's life may be preserved since it may not be used to power GPS tracking and notification (i.e., the GPS receiver and cellular or satellite modem). The battery's life may be preserved as well since, as stated, GPS tracking and notification may remain deactivated for false alarms reporting.

If however the person does not return to a location within the proximity communication distance within a predefined period of time after the first alert/notification, GPS tracking and notification then be activated by powering on the GPS receive and/or cellular or satellite transceiver, by utilizing a power switching circuitry which is responsive to cold start (Power ON) the GPS/cellular power circuitry only upon tracking unit communication is lost with the home base unit. Contrary to teachings found in the prior arts where a “Sleep mode” or “power saver” mode or “standby” mode methods has been utilized, which each one of such prior methods drains constant low current consumption from the battery, and if presumably an external power On/Off switch was used in the prior arts to control un-necessary power drain from the battery, by user turning manual On/Off switch to control GPS tracking power circuitry, that presumption will not be practical in use at all, because subject to be monitored before leaving a selected proximity area may forget to turn On the GPS unit power switch, and the art becomes completely useless.

The GPS tracking system may include a Bluetooth™ transceiver, which is securely attached to a person with a tamper detection strap. This may be used to ascertain if the user is attached to the device and able to communicate with two way voice data with a headset and create a communication link with a monitoring station via the tracking device cellular or satellite transceiver. The conversation between the person and monitoring station personnel (e.g., probation officer) can thus be kept private since audio signals are received at and emitted from the wireless headset. This is advantageous since low volume making it difficult or impossible for those nearby to overhear or eavesdrop on the discussion. Since the tracking device is tamper proof and it is securely attached to the person there for it ascertains user to receive an incoming call from a monitoring station.

It is primary objective of the present invention to provide a GPS tracking system securely attached to a person or asset and designed to establish RF communication with a home base unit when the tracking system is located within proximity of a home base unit. The tracking unit may be designed to generate warning signals when the person attached with a tracking device wonders away from the boundaries of the home base unit, and warn the user to return back to home base unit RF communication range, to avoid the tracking device from falls reporting indicative user left the proximity of a home base unit and alert the user to avoid GPS tracking devise initiating unnecessary reporting or probation rules and save tracking device cellular or satellite module consuming battery energy.

In a preferred embodiment of the present invention, the device utilizes a first battery to power and operate a tracking device RF transceiver and processor circuitry to communicate with a home base unit, and utilizes a secondary standalone battery specifically to power ON the GPS/Cellular circuitry to provide reserved energy for longer GPS tracking operation. Her each are incorporated herein by reference.

It is accordingly another objective of the present invention to provide GPS tracking that utilizes a battery operated personnel or asset mounted GPS tracking device having a first battery to power a low power consumption RF transceiver, and a processor designed to communicate at predefined time interval(s) with a home base station RF transceiver unit located within the communication range of the GPS tracking device. The tracking device may have a second battery, which will power ON automatically to operate the GPS/Cellular circuitry only when subject being monitored moves away from a pre-select location proximity.

It is accordingly another objective of present invention to use a battery powered GPS tracking unit, wherein when the GPS tracking unit is located within proximity range of a home base unit, the tracking device GPS/Cellular electronic circuitry power consumption is zero, thus utilizing an RF transceiver/processor and a power switching circuitry which is responsive to cold start “power ON” the GPS/cellular power circuitry only when the tracking devise moves away from a pre-set proximity area (creating communication loss with the home base unit). The present art teaching is designed to provide less frequent battery charging for a user.

It is another objective of present invention, to provide monitoring station(s) automatic personnel/asset movement tracking by automatically switching ON GPS/Cellular circuitry battery power only when a person or asset carrying the tracking device moves away from home base unit.

It is a another objective of present invention, to provide a tracking device using a first battery to operate its processor to monitor the absence and/or low battery condition of the secondary battery located within said GPS tracking device, and accordingly generates an audio/visual, vibrating alarm signal(s) to warn the user to replace the secondary rechargeable battery, and/or transmits an RF alarm signal(s) to a monitoring station when the second battery at a predetermined time is not replaced with a fully charged one.

The GPS tracking system of the present invention may utilize two batteries, a rechargeable battery to provide power to the RF transceiver, to the processor and to GPS/cellular or satellite module, and a rechargeable back up battery is used to supply power when the rechargeable battery is removed from the tracking device for charging, the rechargeable battery after being charged is inserted in the tracking devise and used for charging the first back up battery. and a power switching circuitry configured at a predetermined time to transfer power from the rechargeable battery or rechargeable back up battery to the GPS receiver and cellular or satellite transceiver if the confirmation signal is not received after the alerting device is activated at least the first time;

GPS tracking device of the present invention is securely attached to the user limp additionally may contain a two way voice cellular or satellite module having a blue tooth RF transceiver circuitry which is designed to ascertain user to receive incoming phone calls from a monitoring station and accordingly signal the user with audio/visual or vibrating signals to activate the user headset to establish two way voice communication with the monitoring station used for providing wireless two way voice communication in between a person to be monitored carrying a wireless headset, and the monitoring station

And it is another objective of the present invention, wherein the GPS tracking device is securely is attached to a personnel or asset, utilizing an optical sensor to detect GPS tracking device tamper (removal), and use the first battery power to transmit an RF signal containing the tamper detection signal, and use the second battery power to transmit a cellular or satellite signal to ascertain the temper alarm signals is been transmitted to a monitoring station successfully.

These and other objects and advantages of the present invention will become apparent from the subsequent detailed description of the preferred embodiment and the appended claims.

### BRIEF DESCRIPTION OF THE DRAWINGS

This and other advantages of the present invention are best understood with reference to the drawings, in which;

FIG. 1 is a view of a wearable GPS tracking unit having a tamper detection strap, a low power consumption RF transceiver, GPS receiver circuitry, GSM or satellite modem, and a single or dual battery compartment, one for providing power to RF transceiver, and the other providing power to GPS and wireless modem data communicator circuitry.

FIG. 2 is a view of an asset mounted GPS tracking unit having a low power consumption RF transceiver, GPS receiver circuitry, GSM or satellite modem, and a single or dual battery compartment, one providing power to RF transceiver, and the other providing power to GPS and wireless modem data communication circuitry.

FIG. 3 is a view of asset mount a GPS tracking unit having optical tamper detection circuitry.

FIG. 4 illustrates a person and an asset carrying GPS tracking unit, a house equipped with a home base RF transceiver unit, and a monitoring station.

FIG. 5 is a block diagram of the security tracking system.

FIG. 6 is a partial isometric view of the GPS tracking unit used for attaching to a person with a strap, in the alternate embodiment.

FIG. 7 is a partial isometric view of the GPS tracking unit for use for attaching to an asset, in the alternate embodiment.

FIG. 8 is a partial isometric view of the GPS tracking unit ready for attachment to an asset using optical tamper detection circuitry, in the alternate embodiment.

FIG. 9 is a schematic of the basic components of the GPS tracking system, in the alternate embodiment.

FIG. 10A is a block diagram of the GPS tracking system, in the alternate embodiment.

FIG. 10B is a block diagram of the GPS tracking system having a wireless transceiver for communication with a wireless headset.

FIG. 10C is a block diagram of the GPS tracking system having battery charging circuitry.

### DETAILED DESCRIPTION OF THE INVENTION

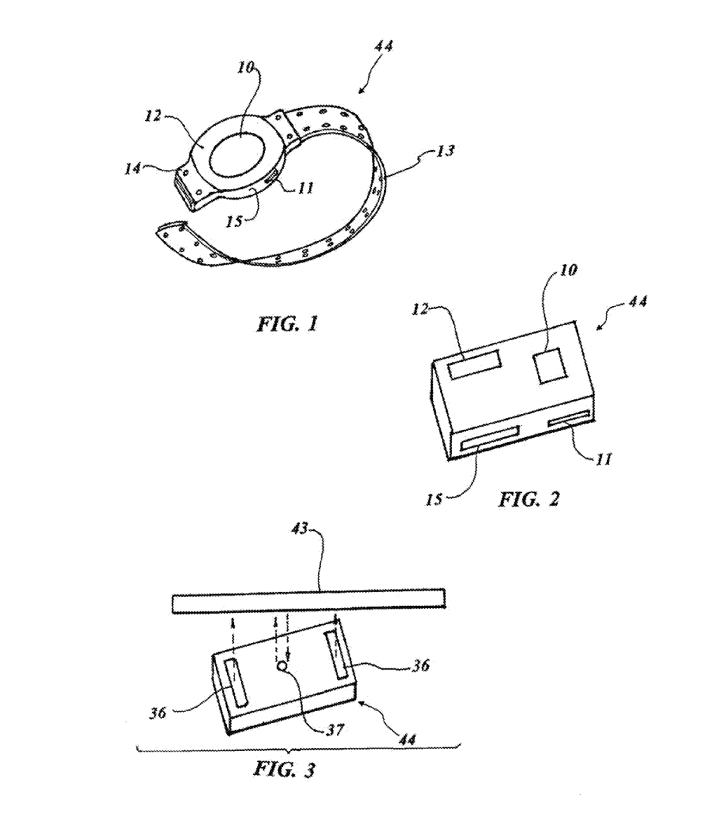

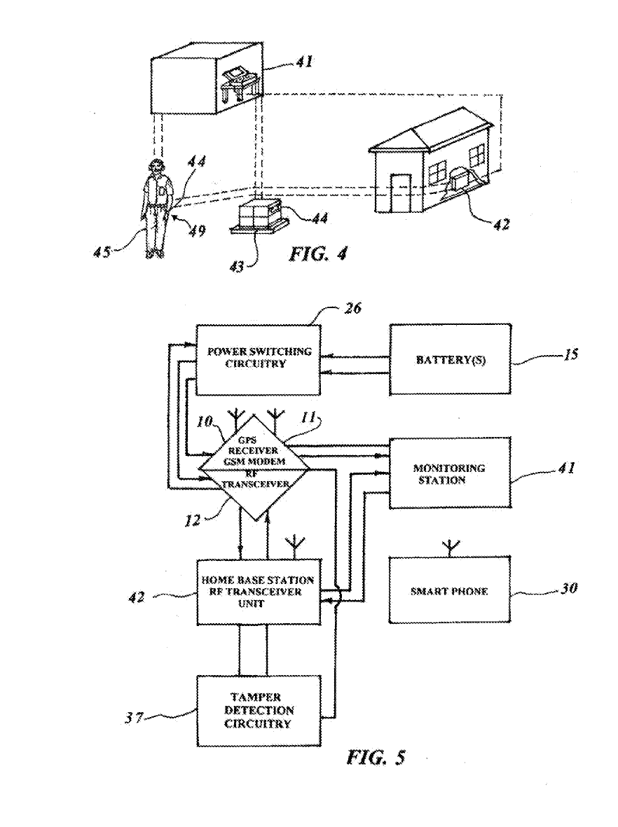

An embodiment of the GPS tracking system is shown in FIGS. 1 through 5 and is comprised of a portable battery operated GPS tracking unit 44 to be mounted on an asset 43 or attached to a person 45, such as the person's wrist or ankle 49, as can be seen in FIG. 4. Referring to FIGS. 1 and 2, the GPS tracking unit 44 may have a wearable configuration, an asset-attached configuration, among other configurations. The GPS tracking unit 44 may include a GPS receiver 10, and a cellular or satellite modem 11. Incorporated in the GPS tracking unit 44, may be a low power consumption RF transceiver 12 using a battery or dual batteries 15. The battery 15 may preferably be a Li-Ion rechargeable battery that provides power to the low power RF transceiver 12, and provides power to a GPS receiver 10 and a wireless communication modem 11 which are also included in the tracking unit 44. The low power consumption RF transceiver 12 may communicate at various predetermined time intervals with a home base station RF transceiver unit 42, located within the communication range of the GPS tracking unit 44. When the GPS tracking unit 44 moves away from the home base unit's communication range, the tracking unit's RF transceiver 12 will cold start “Power ON” the GPS cellular or satellite modem 11 to provide automatic GPS tracking and provide less frequent battery 15 charge to user. In a dual battery embodiment a first battery 15 (preferably Lithium type) may be used to provide power to RF transceiver 12 and a second battery 15 (preferably a Li-Ion rechargeable) may be provided to cold start “Power ON” the GPS receiver 10 and cellular or satellite modem 11 for location tracking purposes. The second battery may only be activated or turned on when the GPS tracking unit 44 moves out of the home base unit's communication range.

FIG. 3 illustrates the GPS tracking unit 44 being attached to an asset 43 utilizing an optical reflection motion/tamper sensor 37 included in the tracking unit 44 that alerts a monitoring station 41 when removed from the asset 43, such as shown in FIG. 4. The tracking unit 44 may be attached to the asset 43 with various fasteners, such as one or more hook and loop straps 36.

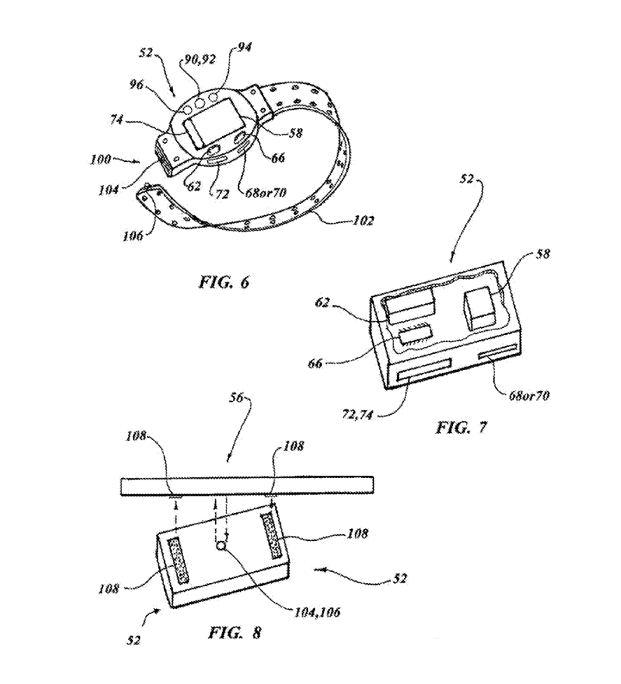

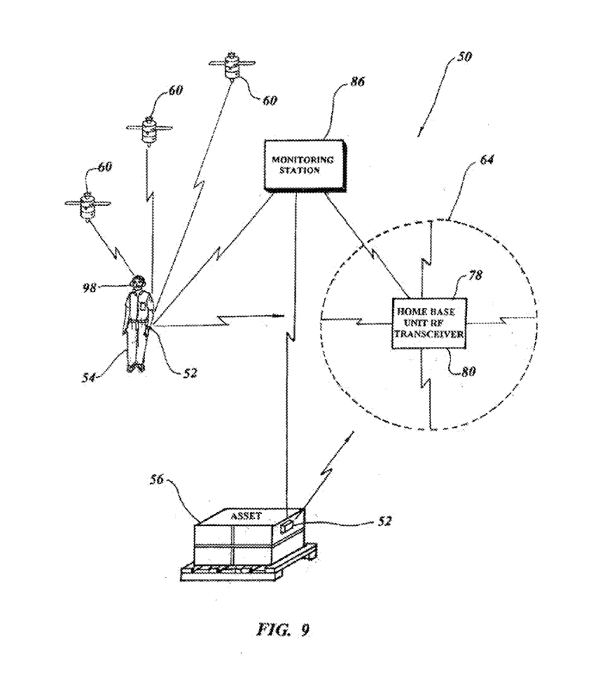

A preferred embodiment of an automatic GPS tracking system, with passive battery circuitry, is illustrated in FIGS. 6 through 10A and consists of a GPS tracking unit 52 that is configured to be secured onto a person 54 or an asset 56, as shown in FIG. 9. The GPS tracking unit 52 may include a first RF transceiver 62 emitting an RF signal, and receiving a confirmation signal from a home base station unit 78 (as shown in FIG. 9), demonstrating that the tracking unit 52 is within a pre-selected proximity communication distance 64.

The GPS tracking unit 52 may also comprise a processor 66 that is configured to control functions of the GPS tracking unit 52 and also to control pre-selected time intervals to send the RF signal from the first RF transceiver 62. A first battery 72 (preferably a Lithium type) may supply constant electrical power to both the first RF transceiver 62 and the processor 66. A GPS receiver 58 in communication with a plurality of satellites 60 acquires the specific physical location of the tracking unit 52. A cellular modem 68 or a satellite modem 70 may be utilized to communicating with a monitoring station 86.

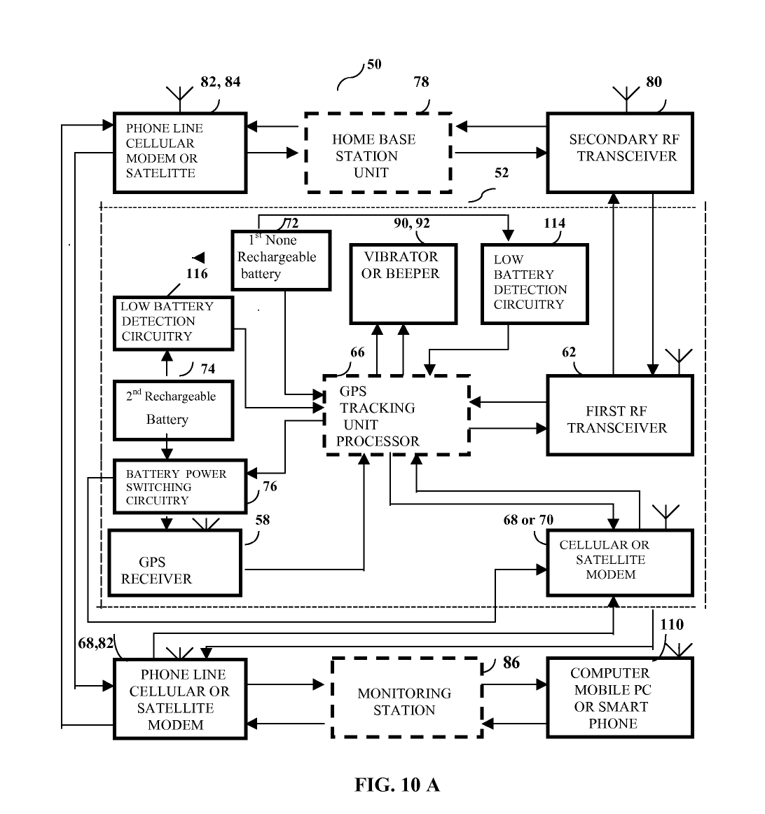

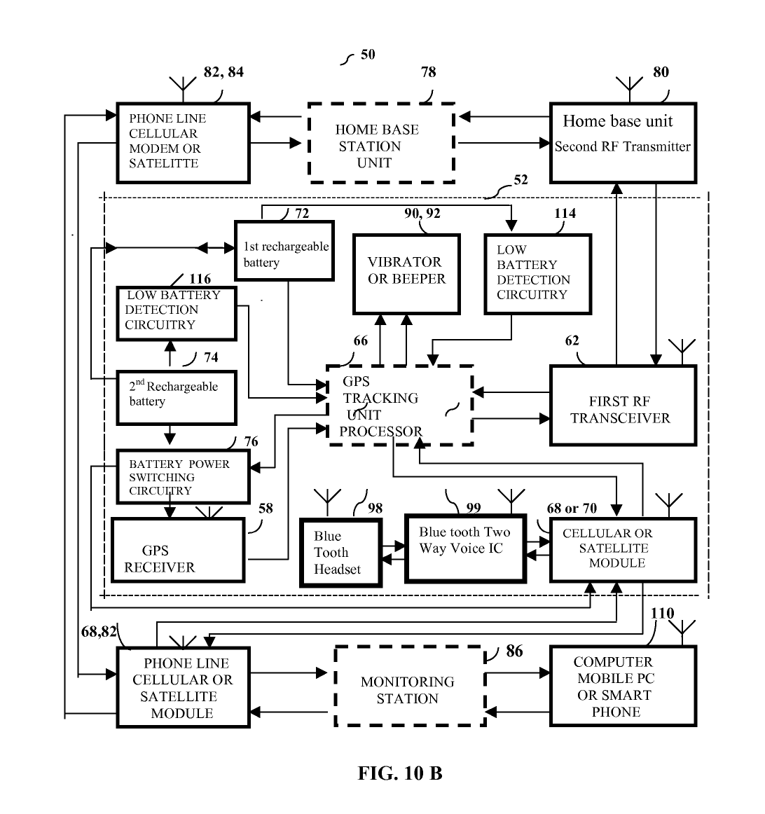

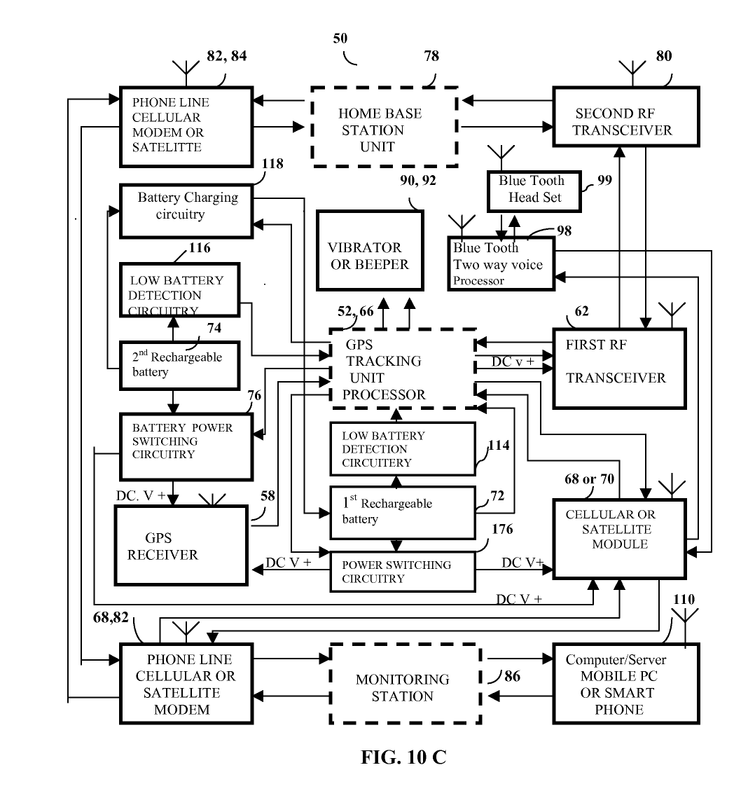

Referring to FIG. 10A, a second battery 74 (preferably a rechargeable Li-Ion type) may supply electrical power to the GPS receiver 58, cellular modem 68, or a satellite modem 70. Power switching circuitry 76 of the GPS tracking unit 52 may interfaces with the second battery 74, and be configured to power on the second battery 74 only when the GPS tracking unit 52 moves away from a pre-selected proximity 64 distance from the home base unit 78, and the RF confirmation signal is not received from the home base unit 78 within the pre-selected time period. When GPS tracking unit 52 enters back into RF communication proximity distance 64, the GPS tracking unit re-establishes communication with the home base unit 78, and the power switching circuitry 76 switches OFF the GPS receiver 58 and cellular modem 68, and satellite modem 70 to conserve power at the second battery 74. This may occur by disconnecting the second battery 74 from the circuit to stop power from flowing to the GPS receiver 58 and cellular modem 68, and satellite modem 70. Saving power at the second battery 74 preserves the amount of time the GPS tracking unit 52 can track a person 54 or asset 56.

Referring to FIG. 9, it can be seen that the GPS tracking system 50 may incorporate a home base station 78. The home base station 78 may have a second RF transceiver 80 which receives the RF signal from the GPS tracking unit 52 first RF transceiver 62. The second RF transceiver 80 may emit a confirmation signal back to the GPS tracking unit 52 indicating that the GPS tracking unit is within the proximity of the home base station 78. This communication/confirmation between the GPS tracking unit 52 and home base station 78 may continue as long as the confirmation signal is received.

In an alternate embodiment of the automatic GPS tracking system, passive battery circuitry may be used, as illustrated in FIGS. 6 through 10. Similar to above, such a system may comprise a GPS tracking unit 52 that is configured to be secured onto a person 54 or an asset 56, as shown in FIG. 9.

In the alternate embodiment, the GPS tracking unit 52 may comprise a first RF transceiver 62 communicating via RF signal(s) with a home base station unit 78, demonstrating that the tracking unit 52 is within a pre-selected proximity communication distance 64. A processor 66 may be programmed to control functions of the GPS tracking unit 52 and also control pre-selected communication time intervals of the RF signal(s) from the first RF transceiver 62. A first battery 72 (preferably a Lithium type) may supply constant electrical power to both the first RF transceiver 62 and the processor 66. A GPS receiver 58 in communication with a plurality of satellites 60 may be configured to acquire the specific physical location of the GPS tracking unit 52. A cellular modem 68 or a satellite modem 70 may be utilized to communicate with monitoring station 86.

A second battery 74 (preferably a rechargeable Li-Ion type) may supply electrical power to the GPS receiver 58, cellular modem 68, or a satellite modem 70. The power switching circuitry 76 may interface with the second battery 74 and be configured to power on the second battery 74 only when the GPS tracking unit moves away from a pre-selected proximity communication 64 distance from the home base unit 78. For instance, if the RF confirmation signal(s) are not received from the home base unit 78 within a pre-selected time period, the second battery 74 may be activated, thus powering on the GPS receiver 58 and a cellular modem 68 or satellite modem 70. When the GPS tracking unit 52 enters back into RF communication proximity distance 64, the GPS tracking unit re-establishes communication with the home base unit 78, and the power switching circuitry 76 switches OFF the second battery 74 (and thus also switches off the GPS receiver 58 and cellular modem 68, satellite modem 70) to save battery life of the second battery 74.

The GPS tracking system 50 may incorporates a home base station 78, which may comprise a home base unit second RF transceiver 80 which communicates via RF signal(s) with the GPS tracking unit 52 first RF transceiver 62 and establishes a communication confirmation with the GPS tracking unit indicating that the GPS tracking unit 52 is within the communication proximity distance 64 of the home base station 78 and continues such communication as long as the communication confirmation signal is received.

It is contemplated that a landline phone 82 or a cellular phone 84 may be utilized for establishing communication with the monitoring station 86.

A GPS tracking 52 unit may have only a receiver 62, and a home base station unit 78 may comprise an RF transmitter 80 designed to emit, at predefined time intervals, RF signals. The GPS tracking unit 52 receiver 62 may receive the emitted signals creating a power OFF state for the GPS receiver 58 and cellular or satellite modem circuitry 68, and may create a cold start power ON state for the GPS receiver 58 and cellular modem circuitry 68 only when the tracking unit moves away from a home base station 78 proximity communication range.

The GPS tracking unit 44,52 may be portable, battery operated, and/or asset or personnel mounted. It is noted that the GPS tracking unit 44,52 may further comprise a power On/Off switch (Not shown) and a vibrator 90 or a beeper 92 (or other alerting device) in electrical communication with its processor 12,66. When the first RF transceiver 12, 62 detects RF signal loss, or GPS tracking unit 44, 52 is separated by more than a pre-selected proximity communication distance 64 from the home base station unit 42, 78 and or when the communication confirmation RF signal(s) is not received from the home base station unit 42, 78, the processor 12, 66 accordingly actuates the vibrator 90 or the beeper 92 creating a vibration or an audible alarm signal warning the person to turn on the GPS tracking unit GPS receiver 10, 58 and/or cellular or satellite modem 11, 68 and 70. This may be accomplished by moving or otherwise activating the circuitry power switch into an on position where the first battery 15, 72 or the second battery 15, 74 may be used as a power source to operate the GPS tracking unit 44, 52. The GPS receiver 10, 58, and/or cellular or satellite modem 11, 68, 70 circuitry power switch may be place into an off position when the person or asset to be monitored enters back into communication proximity of a home base unit 42, 78. In one or more embodiments, only the second battery 74 may be used to power the GPS receiver, and/or cellular or satellite modem.

To complete the GPS tracking system 50, in one or more embodiments, a monitoring station 86 may be utilized. Such monitoring station 86 may be a computer or mobile PC 110 for receiving signals from the GPS tracking unit 52, through cellular modem or land phone 82, or for communicating with the GPS tracking unit 52.

The GPS tracking unit 52 may include a vibrator 90 or a beeper 92, as illustrated in FIG. 6, in electrical communication with the processor 66. The processor 66 is programmed to monitor a low battery condition or the absence of the second battery 74, from its compartment and accordingly may activate the vibrator 90 or beeper 92 creating a vibration or an audible alarm signal warning the person 54 or asset 56 to replace or charge the second battery 74. The processor 66 is also programmed to transmit an RF or cellular signal to the monitoring station 86 containing information as to the second battery's condition. The vibrator 90 and beeper 92 are thus responsive to a signal from the monitoring station 86 that may arrive through the home base unit second RF transceiver 80, the cellular modem 68 and/or the satellite modem 70. The vibrator 90 and/or beeper 92 may accordingly vibrate or generate audible sounds providing a notification for the person 54 being monitored to attend to the low battery condition.

The vibrator 90 or beeper 92 also is activated when a person 54 or asset 56 moves out of a proximity communication distance 64 to alert the person is moving away from proximity of a home base unit 78. Such distance may be a predefined distance and may, in some embodiments, be the limited transmission range of the home base unit 78 in some embodiments. In this manner, when a confirmation signal is no longer received from or by the home base unit 78 the GPS tracking unit 52 may determine that it is outside the proximity communication distance 64. For example, if the GPS tracking unit 54 may determine it is outside the proximity communication distance if it fails to receive a confirmation signal from the home base unit 78 within a predefined period of time. The GPS tracking unit 54 may be configured to periodically request or elicit a confirmation signal from the home base unit 78 by signaling the home base unit with its RF transceiver 62.

It is contemplated that the GPS tracking unit 52 may measure signal strength of the signals emitted by the home base unit 78 to determine a distance from the home base unit with weaker signals indicating a further distance away from the home base unit. Whether or not the GPS tracking unit 52 is inside or outside the proximity communication distance 64 may be determined based on this distance measurement. Other ways of determining whether the GPS tracking unit 52 is inside or outside a proximity communication distance 64 may be used as well.

It is configured to activate when the GPS tracking unit 52 is outside a proximity communication distance 64, the vibrator 90 or beeper 92 is used to notify a person 54 wearing the GPS tracking unit 52 that he or she has gone too far from the home base unit 68. The person 54 may then return to a location within the proximity communication distance 64 to avoid additional warnings or consequences. For instance, if the person 54 returns to a location within the proximity communication distance 64 within a predefined time, GPS tracking and notification to a monitoring station (that the person is outside the proximity communication distance 64) may not be activated. This reduces the number of false alarms and allows the person 54 to move more freely without being preoccupied of whether or no he or she is outside the proximity communication distance 64.

In addition, battery life is preserved since GPS tracking and notification may remain deactivated for false alarms. To illustrate, the first battery's life may be preserved since it may not be used to power GPS tracking and notification (i.e., the GPS receiver and cellular or satellite modem). The second battery's life may be preserved as well since, as stated, GPS tracking and notification may remain deactivated for false alarms.

If however the person 54 does not return to a location within the proximity communication distance 64 within a predefined period of time after the first alert/notification, GPS tracking and notification may then be activated by powering on the GPS receive and/or cellular or satellite transceiver with a second battery 74. For example, if a confirmation signal is still not received from the home base unit 78 within a predefined period of time after the first alert/notification (thereby indicating the person 54 is still beyond the proximity communication distance 64), GPS tracking and notification may be activated.

An optional feature of the automatic GPS tracking system 50 utilizes a speaker 94 and a microphone 96, also illustrated in FIG. 6, interfacing with the cellular modem 68 or the satellite modem phone 70, and utilizing the second battery 74 as one of or as a sole power source. The speaker 94 and microphone 96 may be used to establish verbal communication between the person 54 to be monitored and the monitoring station 86 through the cellular or satellite phone modem 68,70 network or through the home base unit 78 second RF transceiver 80 and phone line modem 82,84.

Referring to FIG. 9, a wireless headset 98, including speakers and a microphone, may be carried by the person 54 to be monitored, and the GPS tracking unit 52 may contain RF audio circuitry, connected to the first RF transceiver 62, to the cellular modem 68 or the satellite modem 70, to provide verbal communication between the person 54 to be monitored and the monitoring station 86 through the home base unit 78 second RF transceiver 80, land phone 82 line, or cellular phone 84. This may be used to establish verbal communication between the person 54 and personnel at the monitoring station 86 through the cellular and/or satellite phone line 68, 70.

As can be seen from FIGS. 10B and 10C, the GPS tracking unit 52 may include a wireless transceiver, such as a Bluetooth™ transceiver 99, to communicate voice data between itself and the wireless headset 98 via one or more wireless signals. The Bluetooth transceiver 99 may be powered solely by the second battery 74 in one or more embodiments or may be by both batteries. When in use, the person 54 and the monitoring station 86 may thus communicate verbally through the wireless headset 98 worn by the person 54. The conversation between the person 54 and monitoring station personnel can thus be kept private since audio signals are received at and emitted from the wireless headset 98. This is advantageous since monitoring station personnel may wish to discuss personal or sensitive information (e.g., parole information) with the person 54 required to wear the GPS tracking unit 52. Since the wireless headset 98 is worn or secured to/adjacent the person's head such discussion can be held discretely at low volume making it difficult or impossible for those nearby to overhear or eavesdrop on the discussion. Since the tracking device 52 is tamper proof and it is securely attached to the person 54 there for it ascertains user to receive an incoming call from a monitoring station 86.

It is contemplated that the verbal communication features may be automatically activated when the GPS tracking unit 52 leaves a proximity communication distance 64. For example, voice communication between a person 54 and monitoring station personnel may be automatically initiated when the person 54 is beyond the proximity communication distance 64. Such communication may utilize the Bluetooth transceiver 99 and wireless headset 98 as disclosed above. In this manner, a monitoring station 86 may automatically communicate with the person 54 wearing the GPS tracking unit 52 when the person goes beyond the proximity communication distance 64. Monitoring station personnel may then request information, provide instructions, and otherwise communicate with the person 54, such as to find out why the person is beyond the proximity communication distance 64 and/or to instruct the person to return.

In some embodiments, verbal communication features may only be activated after the person 54 has been given at least one notification (such as via a vibrator, beeper, or other alerting device) that he or she is beyond the proximity communication distance 64. For example, if a confirmation signal from the home base unit 78 is still not received within a predefined period of time after the notification (thereby indicating the person 54 is still outside the proximity communication distance 64), a call or other voice communication may be initiated between a monitoring station and the GPS tracking unit 52.

Referring to FIGS. 6 and 8, tamper protection circuitry 100 may be utilized in the automatic GPS tracking system 50 incorporating a strap 102 for attaching the tracking unit 52 onto the person 54 to be monitored. The GPS tracking unit 52 may also or alternatively be attached to the asset 56 preferably with hook and loop tape 108 as illustrated in FIG. 8.

A processor 66 of the GPS tracking unit 52 may have comparator circuitry, which detects optical signal loss if security is breached by strap 102 removal. The tracking unit 52, using the first battery 72 power to transmit an RF signal containing information of a security breach; simultaneously a cellular signal or satellite signal is transmitted to the monitoring station 86 using power from the second battery 74.

The tamper protection circuitry 100 may be utilized with an asset 56, such as shown in FIG. 9. The tamper protection circuitry 100 may incorporate an optical light emitter 104 and an optical light collector 106 linearly aligned with a surface of the asset 56. The processor 66 may be programmed to contain comparator circuitry which detects optical reflection signal amplitude changes when the GPS tracking unit 52 is tampered or removed from the asset 56. The GPS tracking unit 52 then transmits an RF signal containing information of a security breach using power from a first battery 72, and simultaneously transmits a cellular signal or satellite signal to said monitoring station 86 using power from a second battery 74.

Referring to FIG. 10A, it can be seen that in one or more embodiments the first battery 72 may be a non-rechargeable battery, such as a lithium, alkaline, or other non-rechargeable battery. This battery may be replaced when its power level is low. In other embodiments, the first battery 72 may be rechargeable so that it may be recharged rather than replaced. This reduces or eliminates the need to remove the first battery 72.

For example, FIG. 10B illustrates a GPS tracking system 50 with a GPS tracking unit having a first rechargeable battery 72. As can be seen, the first rechargeable battery 72 may be recharged by the second battery 74, which itself is rechargeable. In this manner, power from the second rechargeable battery 74 may be used to power the first RF transceiver 62 (and other components) to allow communication of signals between the GPS tracking unit and a home base unit 78 to determine and/or detect whether or not a person or asset is within the proximity communication distance, as described above. For instance, in operation, power from the second rechargeable battery 74 may recharge the first rechargeable battery 72, and the now charged first rechargeable battery may power the RF transceiver 62.

It is noted that power transfer from the second rechargeable battery 74 may be regulated. For example, FIG. 10C illustrates an embodiment where battery charging circuitry 118 has been included to regulate the recharging of the first rechargeable battery 72 by the second rechargeable battery 74. In operation, the battery charging circuitry 118 may control the rate at which the first rechargeable battery 72 is recharged by the second rechargeable battery 74, such as to prevent the second rechargeable battery 74 from being excessively drained. In some embodiments, the amount of power transferred from the second rechargeable battery 74 may only be enough to maintain the power level of the first rechargeable battery 72 for example. If the power level of the second rechargeable battery 74 is below a particular threshold, it is contemplated that the battery charging circuitry 118 may prevent additional power from being transferred from the second rechargeable battery to recharge the first rechargeable battery.

It is noted that the battery charging circuitry 118 may also be configured to prevent overcharging of the first rechargeable battery 72, such as by cutting of power transfer when the first rechargeable battery is fully charged. In addition or alternatively, the battery charging circuitry 118 may be configured to start charging the first rechargeable battery 72, such as by transferring power from the second rechargeable battery 74, only when the power level of the first rechargeable battery is below a particular threshold.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

What is claimed is:

1. A portable battery operated asset or personnel GPS tracking system which comprises:
a home base station unit configured to periodically transmit a confirmation signal, said confirmation signal having a limited range; and
a GPS tracking unit having a tamper detection circuitry which securely is attached to an asset or a personnel:
an RF receiver configured to receive the confirmation signal from said home base station unit, said RF receiver powered by a first battery;
a GPS receiver configured to determine a location of said GPS tracking unit;
a cellular or satellite transceiver configured to transmit said GPS tracking unit location to a monitoring station;
a second battery in electrical communication with said GPS receiver and said cellular or satellite transceiver, said second battery not in electrical communication with said RF receiver;
a processor coupled to an alerting device, said processor configured to activate said alerting device a first time to indicate said GPS tracking unit is beyond said limited range of said home base station unit when said confirmation signal is not received from said home base station unit; and
power switching circuitry configured at a predetermined time to transfer power from said second battery to said GPS receiver and cellular or satellite transceiver if said confirmation signal is not received after said alerting device is activated said first time.

2. The portable battery operated asset or personnel GPS tracking system of claim 1, wherein said home base station unit is configured to receive a first RF signal from said GPS tracking unit and to send said confirmation signal in response, and said RF transceiver of said GPS tracking unit is configured to send said first signal to said home base station unit.

3. The portable battery operated asset or personnel GPS tracking system of claim 1, wherein said alerting device is a vibrator or beeper used to alert said personnel when said confirmation signal is not received from said home base station unit.

4. The portable battery operated asset or personnel GPS tracking system of claim 1, wherein said alerting device is further configured to activate a second time after said first time when said confirmation signal is received from said home base station unit to indicate said GPS tracking unit is within said limited range of said home base station unit.

5. The portable battery operated asset or personnel GPS tracking system of claim 4, wherein a first alert is generated by activating said alerting device said first time, and a second alert is generated by activating said alerting device said second time, said second alert being distinct from said first alert.

6. The portable battery operated asset or personnel GPS tracking system of claim 1, wherein said processor is further configured to initiate voice communication with a wireless headset and a monitoring station via said wireless transceiver of the GPS tracking unit and said cellular or satellite transceiver after said alerting device is activated said first time.

7. The portable battery operated asset or personnel GPS tracking system of claim 1, wherein said first battery is rechargeable and said GPS tracking unit comprises battery charging circuitry to recharge said first battery with power from said second battery.

8. The portable battery operated asset or personnel GPS tracking system of claim 1, wherein said GPS tracking unit further comprises an optical sensor configured to detect when said GPS tracking unit is tampered or removed from said asset or personnel, said processor configured to transmit said tamper or unit removal detection signal(s) to a monitoring station along with information to said GPS tracking unit location, and wherein said processor is further configured to activate said alerting device when such removal is detected.

9. A portable battery powered personnel GPS tracking unit having a tamper detection circuitry and securely attached to a personnel comprising:
an RF transceiver configured to receive one or more confirmation signals from a home base station unit;
a processor configured to determine if said one or more confirmation signals from said home base station unit are received within a predefined time period;
a first battery configured to power said RF transceiver and said processor,
a GPS receiver configured to determine a location of said asset or personnel;
a cellular or a satellite transceiver configured to transmit said location of said asset or personnel to a monitoring station;
a wireless audio transceiver configured to establish two way voice communication between said monitoring station and said personnel;
a second battery configured to power said GPS receiver, said cellular or satellite transceiver, and said wireless audio transceiver; and
power switching circuitry configured to control a flow of power from the second battery to the GPS receiver and the cellular or satellite transceiver, wherein said power switching circuitry transfers power from the second battery to the GPS receiver, cellular or satellite transceiver, and wireless audio transceiver if said processor does not receive said one or more confirmation signals within said predefined time period.

10. The portable battery powered personnel GPS tracking unit of claim 9, wherein said processor automatically initiates said two way voice communication between said with said wireless audio transceiver if said processor does not receive said one or more confirmation signals within said predefined period of time.

11. The portable battery powered personnel GPS tracking unit of claim 9 further comprising an alerting device consisting of a vibrator or beeper, wherein said processor activates said alerting device a first time if said processor does not receive said one or more confirmation signals within said predefined time period.

12. The portable battery powered personnel GPS tracking unit of claim 11, wherein said processor activates said alerting device a second time after said first time if said processor receives said one or more confirmation signals after said predefined time period.

13. The portable battery powered personnel GPS tracking unit of claim 9 further comprising battery charging circuitry configured to charge the first battery with power from the second battery if a power level of the first battery is below a predefined threshold.

14. The portable battery powered personnel GPS tracking unit of claim 9 further comprising an optical sensor configured to detect if the GPS tracking unit is tampered or removed from the asset or personnel.

15. A method for tracking an asset or personnel using a GPS tracking system comprising:
transmitting a first confirmation signal from a home base station unit, said confirmation signal having a limited range;
receiving said first confirmation signal from said home base station at a portable GPS tracking unit;
generating a first alert with an alerting device of said portable GPS tracking unit if said first confirmation signal is not received by said portable GPS tracking unit within a first predefined time period, wherein said first alert indicates said asset or personnel is beyond said limited range;
activating a second battery to power a GPS receiver and a cellular or satellite transceiver of said portable GPS tracking unit if a second confirmation signal from said home base station unit is not received within a second predefined period of time after said first alert;
detecting a location of the asset or personnel with the GPS receiver; and
transmitting said location to a monitoring station with the cellular or satellite transceiver.

16. The method of claim 15 further comprising transmitting a first RF signal from the GPS tracking unit, wherein said home base station unit transmits said first confirmation signal in response to receiving said first RF signal.

17. The method of claim 15 further comprising generating a second alert with said alerting device if said second confirmation signal is received by said portable GPS tracking unit within said second predefined period of time after said first alert, wherein said second alert is distinct from said first alert to indicate said asset or personnel is within said limited range.

18. The method of claim 15 further comprising communicating voice data between said portable GPS tracking unit and a wireless headset via a wireless transceiver of said portable GPS tracking unit.

19. The method of claim 15 further comprising initiating voice communication at the portable GPS tracking unit via a cellular or satellite transceiver of said portable GPS tracking unit if said second confirmation signal from said home base station unit is not received within said second predefined period of time after said first alert.

20. The method of claim 19, wherein said voice communication is initiated between said portable GPS tracking unit and said monitoring station via said cellular or satellite transceiver.

21. The method of claim 19, wherein said voice communication is initiated by receiving a call from said monitoring station using said cellular or satellite transceiver.

22. The method of claim 15 further comprising charging said first battery with said second battery if a power level of said first battery is below a predefined threshold.

23. A portable battery operated asset or personnel GPS tracking system comprising:
a home base station unit configured to transmit a confirmation signal, said confirmation signal having a limited range;
a GPS tracking unit having a tamper detection circuitry, said GPS tracking unit securely attached to an asset or a personnel;
an RF receiver configured to receive said confirmation signal from said home base station unit;
a GPS receiver configured to determine a location of said GPS tracking unit;
a cellular or satellite transceiver configured to transmit said GPS tracking unit location to a monitoring station;
a processor coupled to an alerting device, said processor configured to activate said alerting device a first time to indicate said GPS tracking unit is beyond said limited range of said home base station unit when said confirmation signal is not received from said home base station unit;
a rechargeable battery to provide power to said tracking device electronic circuitry, and a rechargeable back up battery used as power supply when said rechargeable battery is removed for charging, said GPS tracking device including electronic circuitry for said rechargeable battery to charge said rechargeable back up battery; and
power switching circuitry configured at a predetermined time to transfer power from said rechargeable battery or rechargeable back up battery to said GPS receiver and cellular or satellite transceiver if said confirmation signal is not received after said alerting device is activated said first time.

24. The portable battery operated asset or personnel GPS tracking system of claim 23 further comprising a wireless audio transceiver configured to communicate with a wireless headset to establish two way voice communication between a monitoring station and said personnel via said GPS tracking unit cellular or satellite transceiver.

25. The portable battery operated asset or personnel GPS tracking system of claim 23 further comprising battery charging circuitry configured to charge the first battery with power from the second battery if a power level of the first battery is below a predefined threshold.

26. A portable battery powered personnel GPS tracking unit having RF audio transceiver, a tamper detection circuitry and it is securely attached to a personnel to ascertain said personnel carrying said tracking unit, said tracking unit in response to at least one received incoming call from a monitoring station establishes two way voice communication between said personnel and said monitoring station, and provide said personnel location information to said monitoring station, said system comprising:
a battery configured to power said GPS tracking unit electronic circuitry,
a GPS receiver configured to determine a location of said personnel;
a cellular or a satellite RF transceiver configured to establish to way voice communication and configured to transmit said personnel location information to a monitoring station; and
a wireless personnel headset,
said wireless audio transceiver configured to communicate with said wireless headset to establish a private two way voice communication between said personnel and a monitoring station via said tracking device cellular or satellite transceiver.

27. A portable battery operated asset or personnel GPS tracking system comprising:
a home base station unit configured to communicate with a GPS tracking unit with confirmation signal, said confirmation signal having a limited range;
a motion detector used for tamper or movement detection of said home base station unit,
a GPS tracking unit having a tamper detection circuitry, said GPS tracking unit securely attached to an asset or a personnel;
an RF receiver or a transceiver configured to receive said confirmation signal from said home base station unit;
a GPS receiver configured to determine a location of said GPS tracking unit;
a cellular or satellite transceiver configured to transmit said GPS tracking unit location to a monitoring station;
a processor is used to control the operation of said tracking device,
a battery to provide power to said tracking device electronic circuitry;
said home base station motion detector in response to detecting motion detection, transmits an RF alarm signal to a monitoring station via said GPS tracking unit cellular or satellite transceiver containing information to said home base station unit, to alert the monitoring personnel said home base unit is been tampered or moved from it's defined location.

28. The portable battery operated asset or personnel GPS tracking system of claim 27 further comprising; a cellular or satellite transceiver designed to transmit said home base station unit motion detection signal to a monitoring station, to alert the monitoring personnel said home base unit is been tampered or moved from it's defined location.
